(19) United States
(12) Patent Application Publication
(10) Pub. No.: US 2015/0339443 A1
(43) Pub. Date: Nov. 26, 2015

(54) OPERATOR DOCUMENTATION AND INFORMATION SYSTEM AND METHOD

(71) Applicants: David A. Hammond, Tinton Falls, NJ (US); Edwards O'DONNELL, Tinton Falls, NJ (US)

(72) Inventors: David A. Hammond, Tinton Falls, NJ (US); Edwards O'DONNELL, Tinton Falls, NJ (US)

(21) Appl. No.: 14/407,870

(22) PCT Filed: Dec. 12, 2012
(86) PCT No.: PCT/US12/00573

§ 371 Date: Dec. 12, 2014

(51) Int. Cl. G06F 19/00

(52) U.S. Cl. CPC G06F 19/323

(57) ABSTRACT

A system and method which provides health care personnel located in remote areas with medical treatment information is disclosed. The system may comprise one or more of: (i) one or more modular handheld units, or other computerized, central processing unit or hardware based user interface, which are capable of receiving and/or storing medical information and/or other content, such as, for example medical procedures, skills, techniques, protocols, and patient specific information; (ii) a server, or other data processing unit, which may itself comprise a central processing unit, data storage devices, and/or or other computerized processing and storage devices, through which content and other information, such as medical procedures, and patient information, as well as system functional applications, may be disseminated or made otherwise accessible to handheld units; and/or (iii) one or more electronic field medical cards (“EFMC's”), which are portable data storage devices (such as for example, a USB thumb drive) capable of storing patient specific data, which data may be uploaded or downloaded to or from the handheld unit and/or the server.

### CROSS-REFERENCE TO RELATED APPLICATIONS

This application claims the priority of U.S. Provisional Patent Application Ser. No. 61/630,505, filed Dec. 12, 2011, entitled “Operator Document and Information System and Method”, the entirety of which is incorporated herein by reference.

### FIELD OF THE INVENTION

This invention is directed to a system and method for disseminating information in real time. More specifically, this invention is directed to a system and method for providing health care personnel located in remote areas with medical treatment information, and enabling such health care personnel to provide information regarding the condition of a patient located in such remote area to other members of a medical team regardless of their location. The invention is further directed to a system and method for enhancing interaction between medical personnel located in remote areas and medical personnel located in other areas via audio, video and text media. The system and method of this invention also permits up-to-date medical information to be available to a multiple member medical team in a substantially simultaneous manner regardless of location. The system and method of this invention also increases the accuracy, and simplifies the exchange of information between multiple members of a medical team regardless of the team member location.

### BACKGROUND OF THE INVENTION

Providing health care in isolated environments is as unique as the role of the medical personnel who administer it. This is particularly true in the administration of health care in military field applications. In military field applications health care professionals, such as Advanced Tactical Providers, typically administer health care to casualties right on the battlefield under combat conditions where there are limited supplies, expertise and time to administer appropriate health care to such casualties. Unlike health care administered in locations where the patient is usually minutes to hours away from the next echelon of care, health care administered in remote operational environments often requires managing a patient's condition for an extended period of time and in austere conditions until evacuation to the next echelon of care becomes available. Additionally, and particularly in the case of humanitarian and stabilization operations, operations in remote third world regions or other non-combat related situations, many of the health care procedures, conditions and cases encountered are not be within the immediate recall or knowledge base of the health care provider who is administering the health care.

In addition, and particularly on the battlefield where the entire focus must be on achieving mission objectives and the stress levels of the casualty and the person administering treatment (who may or may not be a trained professional) are high, it is essential to accurately capture, retain and transfer casualty care data so that such data may be received by the next echelon of care. Recent figures show that of the 30,000 plus wounded in OEF/OIF, less than ten percent (10%) had any form of pre-hospital documentation of care related to casualties, and only one percent (1%) of all documented cases contained adequate information. History has proven that increasing the ability of war fighters to survive their battlefield injuries starts with the warrior's themselves. The unique environment and unconventional tactics of current military engagements make the rapid availability of training medical personnel problematic.

Thus, there exists a need for a system and method for providing medical personnel in the field with ready access to reliable medical information, and particularly medical diagnostic and procedural information, so that the medical professional can provide immediate care to casualties. The need also exists for a system and method for accurately taking and/or retaining casualty medical information, status and documentation from field Tactical Combat Casualty Care related to each casualty, and transferring such information, status and documentation to the next echelon of care.

### SUMMARY OF THE INVENTION

The need for providing medical personnel with ready access to reliable medical information, and particularly medical diagnostic and procedural information, so that the medical professional can provide immediate care to patients, and particularly patient's located in remote locations, is achieved by the system and method of this invention. Moreover, the need for providing a system and method for accurately taking, retaining patient medical information, status and documentation related to each patient, and transferring such information, status and documentation to the next echelon of care, is also achieved by the system and method of this invention.

The system and method of the instant invention provides a medical professional, such as a first medical responder, with accurate diagnostic, medical condition management information, and guidance in a “knowledge on demand” format, in multiple learning modalities. Because it is not always possible to access computerized systems for information and communications from remote locations, in one embodiment, the invention comprises a self-contained hardware and software platform, such as a handheld Android™ based unit, which is not dependent on external connectivity with other system components. Such a system (including system hardware and software) may also be capable of accepting downloads of data, content and other information and materials through an external secure system to keep the handheld unit updated with medical information and content. Such information, data and other content may include but not be limited to medical procedures, skills, techniques, protocols, and patient specific information.

The system and method of this invention may include, but may not be limited to one or more modular handheld units, or other computerized, central processing unit or hardware based user interface, which is capable of receiving and storing medical information and content, such as medical procedures, skills, techniques, protocols, and patient specific information. The information and content may be readily accessible to a user of the handheld in pictorial, textural, video, animated, audio and/or other formats. The information and content also may be categorized into treatment specific, patient specific and/or other categories to permit the user of the handheld to rapidly access such information and content.

The medical and communication limitations available in remote operational environments have provided the base on which the modular system of this invention is based. The prerequisite for the formulation, the refinements, and the development of the system and method of this invention is based upon the relevance and benefit to the patient and the provision of medical treatment by medical personnel in isolated environments.

The system and method of the instant invention may further comprise a central processing unit or other computerized device, such as a server, through which content and other information, such as medical procedures and patient information to the modular handheld units, may be disseminated. The server may also be configured to receive such content and other information from the handheld units. The information and content may be readily accessible to a user of the handheld in visual, video, animated and/or audio formats. The server may further comprise an internet based system having a secure portal through which users and administrators of the system of the invention may access the content, data and other information contained on the server and/or handhelds, and/or generally access the administrative functions of the system.

### BRIEF DESCRIPTION OF THE DRAWINGS

Understanding of the present invention will be facilitated by consideration of the following detailed description of the embodiments of the present invention taken in conjunction with the accompanying drawings, in which like numerals refer to like parts, and wherein:

FIG. 1 is schematic of one embodiment of the system of the instant invention.

FIG. 2 is schematic of another embodiment of the system of the instant invention.

FIG. 3 depicts front, back, side and top elevation views of a handheld unit of one embodiment of the instant invention.

FIG. 4 depicts the detail of the control buttons located on the front surface of the embodiment of the invention of FIG. 3.

FIG. 5 depicts a schematic of a prospective view of the top of the handheld of FIG. 3 having the top cover removed.

FIG. 6 depicts a schematic of a prospective view of the bottom of the handheld of FIG. 3 having the bottom cover removed.

FIG. 7 contains information related to the structure and operation of the handheld of FIG. 3, and the electronic field medical card (EFMC) of the present invention.

FIG. 8 contains additional information related to the structure and operation of the handheld of FIG. 3, including specifications and applications of one embodiment of the invention.

FIG. 9 is schematic of another embodiment of the system of the instant invention.

FIG. 10 is schematic of yet another embodiment of the system of the instant invention.

Additional documents attached hereto constitute additional teachings included in the present invention.

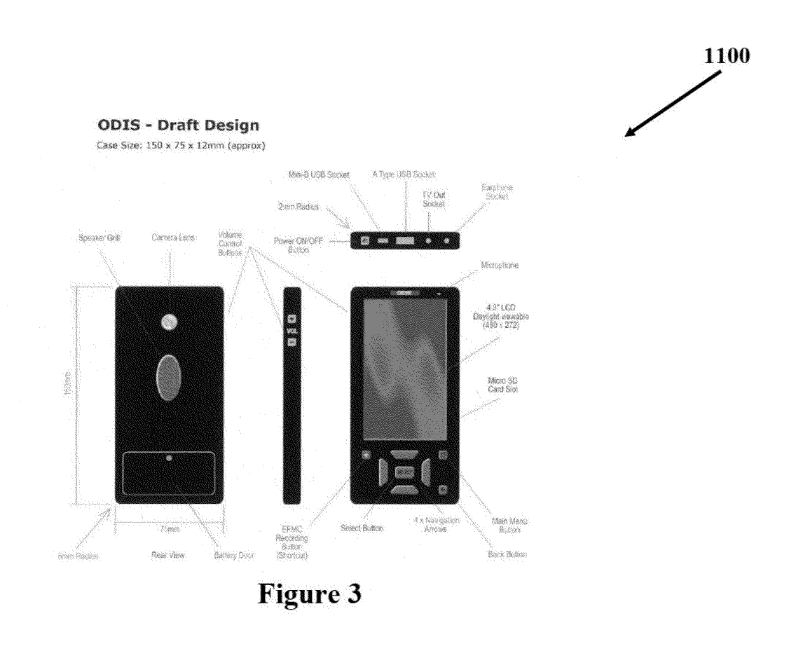

Appendix A attached hereto comprises pages A000001 through A000128 which contain screen shot images from one embodiment of the handheld device of the present invention (such as the handheld depicted in FIG. 3), and which images are incorporated by reference in there entireties herewith.

Appendix B attached hereto comprises pages B000001 through A000046 which contain screen shot images from one embodiment of the portal of the internet based computerized system of the present invention (such as the portal appearing at, for example, www.odiscentral.com), and which images are incorporated by reference in there entireties herewith.

### DETAILED DESCRIPTION OF THE EMBODIMENTS

It is to be understood that the figures, images and descriptions of the present invention have been simplified to illustrate elements that are relevant for a clear understanding of the present invention, while eliminating, for the purposes of clarity, many other elements which may be found in the present invention. Those of ordinary skill in the pertinent art will recognize that other elements are desirable and/or required in order to implement the present invention. However, because such elements are well known in the art, and because such elements do not facilitate a better understanding of the present invention, a discussion of such elements is not provided herein.

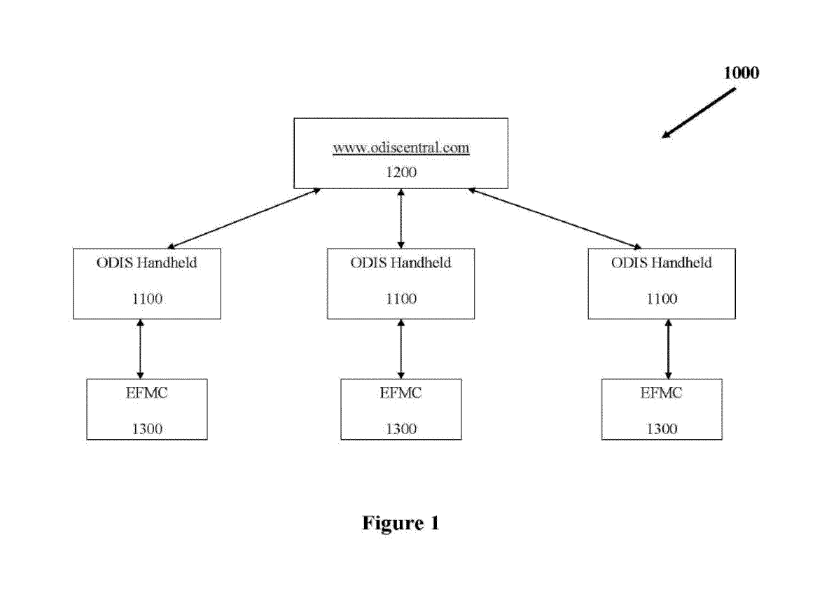

Turning now to FIG. 1, there is shown system 1000 of one embodiment of the instant invention. System 1000 may comprise one or more of: (i) one or more modular handheld units 1100, or other computerized, central processing unit or hardware based user interface, which are capable of receiving and/or storing medical information and/or other content, such as, for example medical procedures, skills, techniques, protocols, and patient specific information; (ii) server 1200, which may itself comprise a central processing unit, data storage devices, and/or or other computerized processing and storage devices, through which content and other information, such as medical procedures, and patient information, as well as system 1000 functional applications, may be disseminated or made otherwise accessible to handheld units 1100; and/or (iii) one or more electronic field medical cards (“EFMC's”) 1300, which are portable data storage devices (such as for example, a USB thumb drive) capable of storing patient specific data, which data may be uploaded or downloaded to or from handheld unit 1100 and/or server 1200.

Medical data, content, and other non-medical information as well as functional applications may be made available to users of system 1000, particularly through handheld units 1100. Such data, content, information and applications may be readily accessible to a user of unit 1100 in pictorial, textural, video, animated, audio and/or other formats. The data, content and other information also may be categorized into treatment specific, patient specific and/or other categories to permit the user of the handheld to rapidly access such information and content.

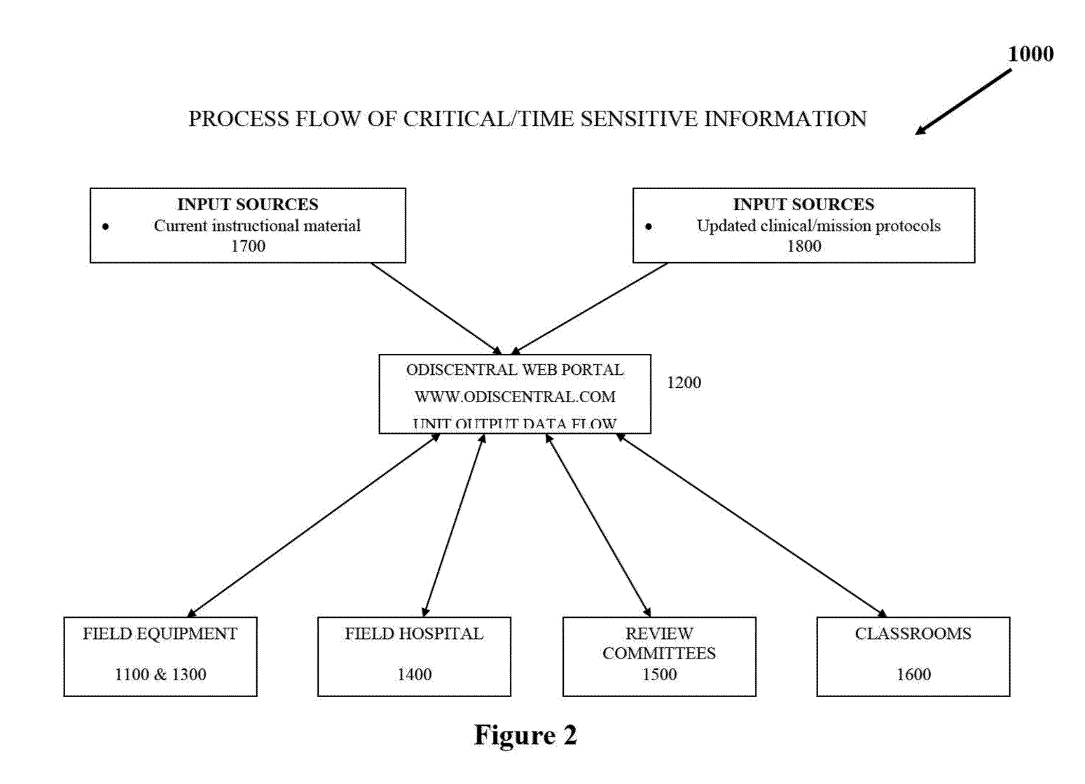

FIG. 2, depicts one embodiment of the flow of information and data through system 1000 of the instant invention. In this embodiment, server 1200 receives, stores, makes available for retrieval and/or transmits information and data from one or more input sources 1700 and 1800. Information and data may also be received from other sources external to server 1200, stored by or in server 1200, retrieved by sources external to server 1200, and/or transmitted by server 1200 to sources external to server 1200. For example, and with reference to FIG. 2, information and data may be received from, retrieved by, and/or transmitted to one or more handheld units 1100 (with or without EFMC 1300). Similarly, information and data may be received from, retrieved by, and/or transmitted to one or more field hospitals and/or other medical facilities 1400, review committees and other individuals or authorities 1500, classrooms an other educational organizations and/or facilities 1600, and/or other sources internal or external to system 1000.

In one embodiment of the instant invention, the applications and information available to a user of handheld unit 1100 are depicted in Appendix A. See Appendix A attached hereto at A000001 through A000128.

### Select Features of Handheld Unit 1100

In one embodiment of the invention, along the top surface of handheld unit 1100 depicted in FIGS. 3 through 6, there is a power button, a micro USB port, a full size USB port, a TV out composite jack, and a 3.5 mm headphone jack. On the left side of handheld unit 1100 are volume control buttons. Along the right side of handheld unit 1100, may comprise a micro SD card slot. On the rear surface of handheld unit 1100, may comprise a camera lens and flash, and below the flash may be a speaker.

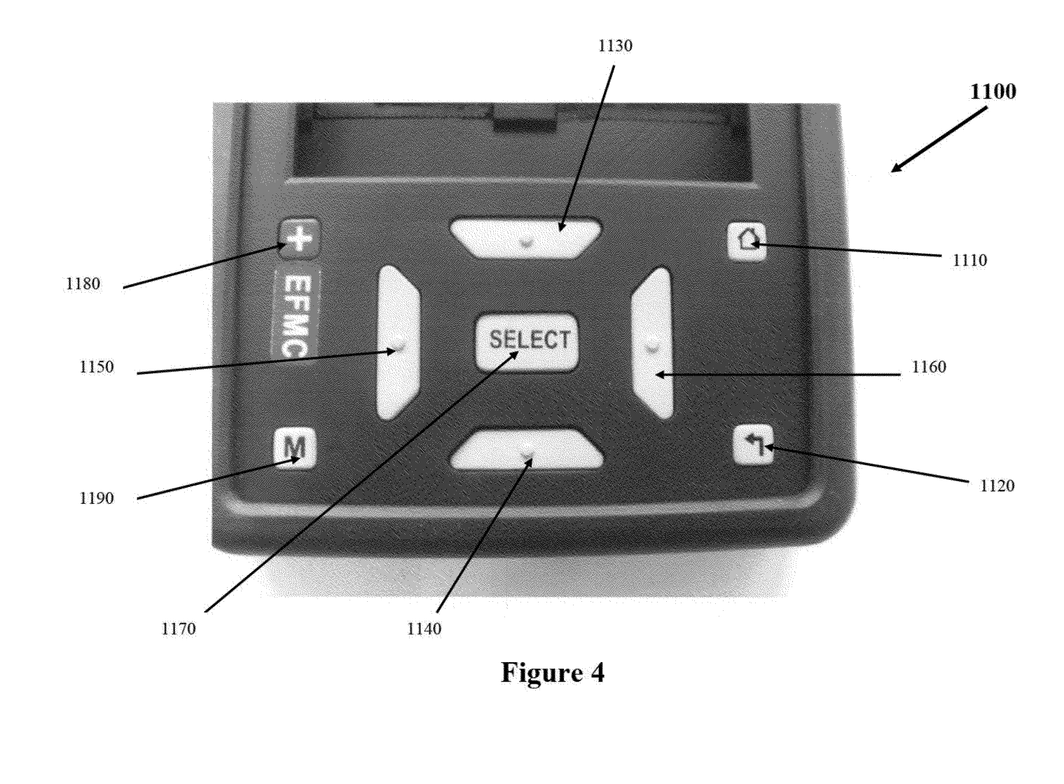

The front surface of handheld unit 1100 may comprise a 4.3 inch daylight readable LCD screen. With reference to FIGS. 3 and 4, underneath the screen are four (4) navigation buttons 1130, 1140, 1150 and 1160, with select button 1170 in the middle. To the left of navigation buttons 1130, 1140, 1150 and 1160 are two buttons: red EFMC button 1180, which is a shortcut which activates the electronic field medical card EFMC application. Underneath EFMC button 1180, is menu button 1190. Home button 1110 is situated to the upper right of navigation buttons 1130, 1140, 1150 and 1160. Back button 1120 is to the lower right of navigation buttons 1130, 1140, 1150 and 1160.

### Handheld 1100 Applications

In one embodiment of the invention as depicted in Appendix A, applications which may be installed on ODIS handheld device 1100 may include, but not be limited to:

### Electronic Field Medical Card

This application enables the user to access and complete an electronic version of a TC3 Medical Card in audio and video form. See Appendix A.

### Tactical Field Care

This application provides step-by-step medical procedures using TC3 guidelines. See Appendix A.

### Combat Medical Sets

This application provides step-by-step instructions on each piece of equipment in the U.S. Army, Marine Corps, Air Force, and Special Operation Forces combat medical sets. See Appendix A.

### IFAKS

This application provides step-by-step instructions on each piece of equipment in the U.S. Army, Marine Corps, Air Force, and Special Operation Forces individual first aid kits. See Appendix A.

### Medications

This application provides information on TC3 medications.

### My Media

My media is a file organizer application for all of the media content which may be captured on ODIS handheld unit 1100. See Appendix A.

### Additional Applications

Additional applications may include: a camcorder, a camera, a voice memo, a calculator, a flashlight, and a stop watch. See Appendix A.

### Audio Room

Also depicted in Appendix A is an audio room application which may comprise a built in MP3 player dedicated to keeping audio files organized for quick and easy access. See Appendix A.

### Library

The library application which may comprise a dedicated ebook and pdf reader. See Appendix A. Handheld unit 1100 may also have the capability to view any ebook using the epub format and may convert content so that such content may be displayed on handheld unit 1100.

### Video Room

The video room application may comprise a built in video application which may access all video recordings stored on system 1000. See Appendix A. For example, audio files, ebooks, pdf documents, photographs, and video recordings may be accessed and downloaded to handheld unit 1100 from server 1200 and/or through www.odiscentral.com.

### EFMC Application

The entire focus of all personnel involved in military battles is on achieving mission objectives. However, the accurate and reliable recording of casualty care provided on the battlefield is essential for proper treatment of casualties at the next echelon of care. The standard method of completing the TC3 field medical cards which are used to record such medical records has been with paper and pencil until the introduction of the instant invention.

System 1000, and particularly handheld unit 1100 individually, or in combination with server 1200 and/or EFMC 1300, provides an efficient, alternate solution by incorporating an EFMC application. The EFMC application may create an audio and/or video treatment record at the point of injury, and which may also be time and date stamped. In addition, data collected through the EFMC application may further accompany the casualty to the next echelon of care.

The EFMC application may be launched through handheld unit 1100 by either highlighting the EFMC application from the home screen of handheld unit 1100 and pressing select button 1170, or by pressing red EFMC shortcut button 1180 located on the front of handheld unit 1100. See Appendix A.

Once launched, the EFMC application will display a start up screen with a brief overview of how to use the application. Menu button 1190 may be pressed at any time to turn on the flashlight on the rear surface of handheld unit 1100 if recording in low light conditions. Pressing select button may automatically begin recording audio and video. Along the bottom of the screen, questions may appear that correspond to the information typically gathered on a traditional TC3 field medical card.

In addition or instead of being displayed on the screen, each question may be audibly asked by handheld unit 1100 and answers may be spoken by the user into a microphone on handheld unit 1100. Pressing select will take the user to the next question. At any time the user may press red EFMC button 1180 to skip the remaining questions and save the file immediately back to handheld unit 1100. Once saved, a date and time stamp treatment record is stored on handheld unit 1100's internal memory until manually deleted by the user.

The user has the option to transfer the EFMC file to USB bullet flash drive 1300. Drive 1300 may accompany the casualty to the next echelon of care. Bullet drive 1300 may also be directly inserted into the USB port at the top of handheld unit 1100. EFMC records stored on handheld unit 1100 may be automatically displayed on handheld unit 1100. The most recent EFMC records may appear at the top of the display list. If it is desired to transfer an EFMC record from those stored on handheld unit 1100 to EFMC drive 1300, the file to be transferred may be chosen from the list displayed on handheld unit 1100 and select button 1170 is pressed to initiate file transfer to EFMC Drive 1300. EFMC bullet drive 1300 will then be loaded with the selected field medical card file, and ready to accompany the casualty to the next echelon of care.

Handheld units 1100 may also optionally comprise a voice memo function which permits the user to dictate into handheld unit 1100 or otherwise create an audio record of observations, treatment being administered or other audio record of a patient's condition, which audio record is then associated with that patient's medical record stored on handheld unit 1100, server 1200, and/or EFMC 1300.

Handheld units 1100 may also optionally comprise a camcorder function which permits the user to make a video recording with handheld unit 1100 or otherwise create an video record of patient status, treatment being administered or other video record of a patient's condition, which video record is then associated with that patient's medical record stored on handheld unit 1100, server 1200, and/or EFMC 1300.

Handheld units 1100 may also optionally comprise a camera function which permits the user to take a photos with handheld unit 1100 or otherwise create an pictorial record of a patient's status, treatment being administered or other photographic record of a patient's condition, which photographic record is then associated with that patient's medical record stored on handheld unit 1100, server 1200, and/or EFMC 1300.

Handheld units 1100 may also optionally comprise a calculator, stop watch, flashlight, EKG or other functions which may be adaptable to and/or useful to a user of handheld units 1100.

System 1000 may optionally comprise server 1200, which may itself comprise a central processing unit, data storage devices, and/or or other computerized processing and storage devices, through which content and other information, such as medical procedures, and patient information, as well as system 1000 functional applications and software upgrades may be disseminated, downloaded, uploaded or made otherwise accessible to handheld units 1100.

In one embodiment of the invention, server 1200 may be configured to receive content, applications and/or other information from handheld units 1100. In yet another embodiment of the invention, handheld units 1100 may be configured to receive content, applications and/or other information from server 1200. System 1000 may also be configured such that both handheld units 1100 and server 1200 are each configured to receive and disseminate such content, applications and/or other information.

The information and other content may be readily accessible to a user of handheld unit 1100 and/or server 1200 in still photographs, video, animated, audio, and/or other suitable formats. Server 1200 may further comprise an internet based system having a secure portal (such as the portal available at www.odiscentral.com and as disclosed in Appendix B hereto pages B000001 through B000046), through which users and/or administrators of system 1000 may access the content, data, functionality and other information contained on server 1200 and/or handheld units 1100, and/or generally access the administrative functions of system 1000.

### The Website/Server 1200

Server 1200, which is in one embodiment of the invention, is accessible through the portal located at www.odiscentral.com, may be configured to provide a dedicated website for digital content used in connection with ODIS handheld unit 1100. Server 1200 may also provide access to approved and relevant professional applications, ebooks, videos, and audio tracks for download onto ODIS handheld unit 1100.

### Electronic Field Medical Card (“EFMC”) 1300

System 1000 may also optionally comprise one or more electronic field medical cards (“EFMC's”) 1300, which themselves may comprise personal portable data storage devices (such as for example, a USB thumb drive) capable of storing patient specific data, which data may be uploaded or downloaded to or from handheld unit 1100 and/or server 1200. EFMC's 1300 may be carried by an individual, wherein EFMC 1300 contains such individual's medical records and other pertinent data. If an individual is in need of medical assistance, a user of handheld unit 1100 may upload such individual's data from EFMC 1300 to handheld unit 1100. Once the user of handheld unit 1100 input into handheld unit 1100 updated data regarding such individual (such as, for example, the individual's current condition, medical treatment which has been administered to the individual, and recommendations for further care), such updated data may be uploaded to EFMC 1300. EFMC 1300 containing the individual's most current medical data may then be personally carried by the individual which is then readily accessible by healthcare providers in subsequent levels of care.

Turning now to FIG. 3, there is shown front, back, and side elevation views, as well as a top view of one embodiment of handheld unit 1100. Handheld unit 1100 may comprise a self-contained hardware and software platform, such as a handheld unit 1100 running the Android™ or other operating system which may provide an open platform for application development. Such operating systems allow for the rapid addition, deletion or modification of applications and other features made available to unit 1100, which may or may not be dependent upon external connectivity with other system components such as server 1200. Such a system (including system hardware and software) may also be capable of accepting downloads of data, content and other information and materials through an external secure system to keep the handheld unit updated with medical information and content. Such information, data and other content may include but not be limited to medical procedures, skills, techniques, protocols, as well as patient specific data and other information.

Turning now to FIGS. 4, 5 and 6, there is shown additional detail and views of the embodiment of Android™ based handheld unit 1100 depicted in FIG. 3.

FIG. 4 depicts detail of the position and type of handheld unit 1100 control buttons or keys located on the front surface of the embodiment of the invention of FIG. 3. Although touch screens may be employed with handheld units 1100, in harsh environments, and particularly in military applications, physical buttons or keys may be preferable because of reliability, durability, and sensory feedback to the user. Such buttons or keys may include, but are not necessarily limited to: home screen button 1110, which returns the image on the screen to the “home” screen; back screen button 1120, which returns the image on the screen to the last screen displayed; screen up, down, left and right cursor buttons 1130, 1140, 1150 and 1160, respectively, which controls the movement of the cursor on the display screen; “Select” button 1170, which selects the function highlighted by the cursor on the display screen; EFMC “+” shortcut button 1180, which launches the EFMC application (and which performs the same function as entering the EFMC application from the main menu on the display screen); and “M” menu button 1180, which displays the menu of functions on the display screen and also may unlock handheld unit 1100 when in a locked mode.

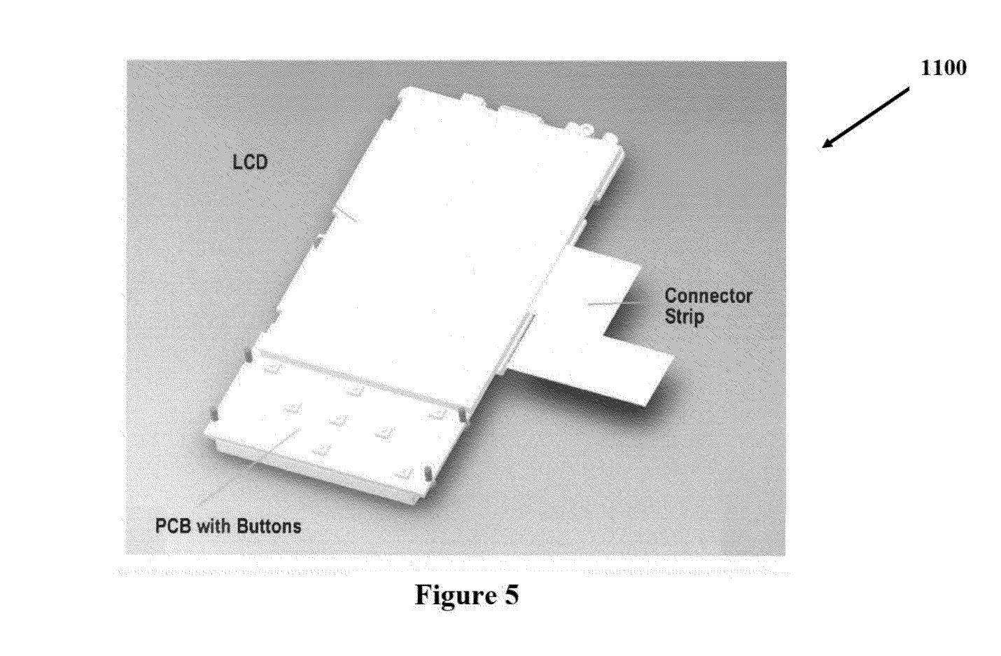

FIG. 5 depicts a schematic of a prospective view of the top of the handheld of FIG. 3 having the top cover removed showing the location of the LCD display, the connector strip and PCB with buttons.

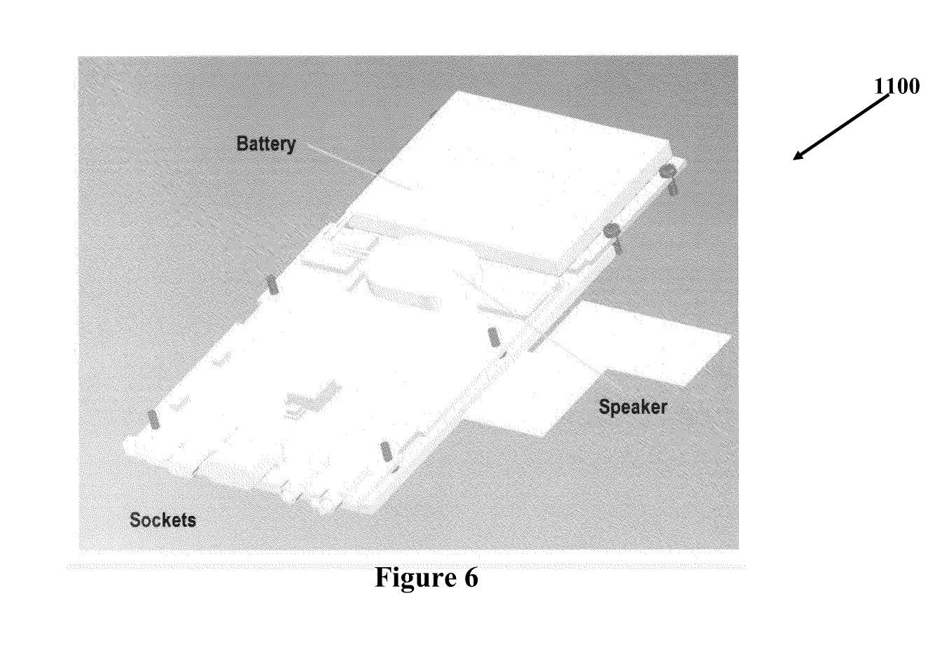

FIG. 6 depicts a schematic of a prospective view of the bottom of the handheld of FIG. 3 having the bottom cover removed showing the location of the battery, speaker and sockets.

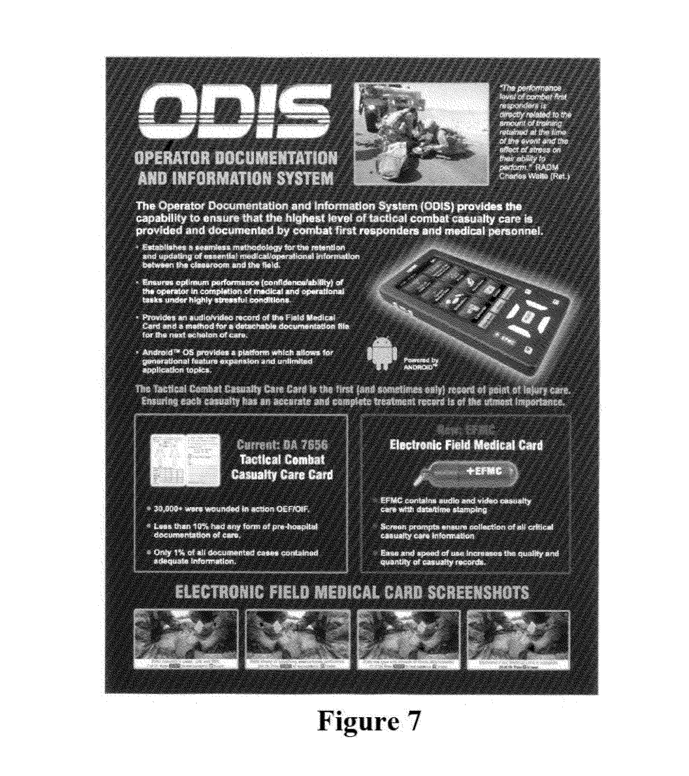

FIG. 7 contains information related to the structure and operation of the embodiment of handheld unit 1100 of FIG. 3, and electronic field medical card (EFMC) 1300 of the present invention.

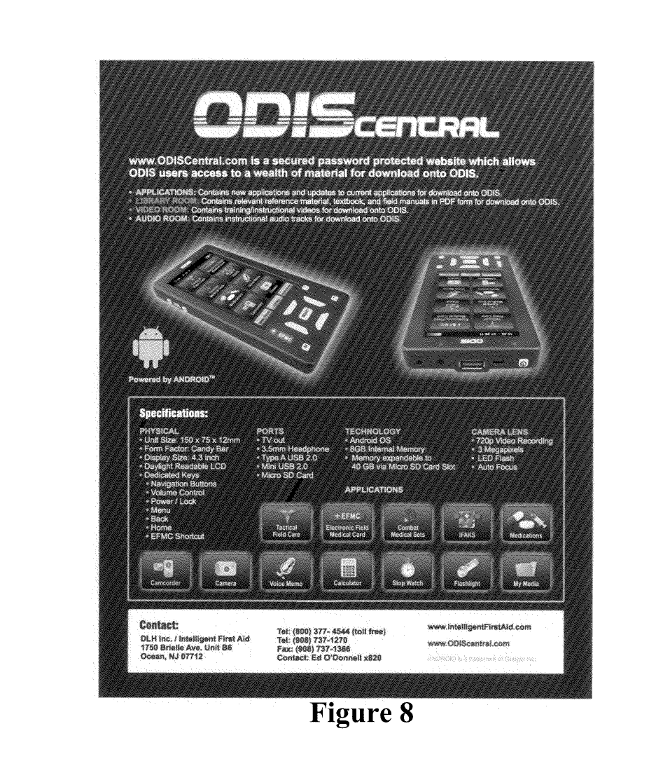

FIG. 8 contains additional information related to the structure and operation of the embodiment of handheld unit 1100 of FIG. 3, including specifications and applications of handheld unit 1100.

Turning now to yet another embodiment of the instant invention, the system and method comprises an Operator Documentation and Information System (also referred to therein as “ODIS”) provides the capability to ensure that the highest level of tactical combat casualty care is provided and documented by combat first responders and medical personnel. ODIS is capable of storing and accessing a large volume of instructional/informational applications to assist the operator in rapid recall and execution of critical skills. ODIS also provides an alternate solution to the standard paper/pencil method of completing the TC3 card (Field Medical Card) by incorporating an Electronic Field Medical Card (also referred to herein as an “EFMC”) application which creates an audio and video treatment record at the point of injury. This record would then accompany the casualty to the next echelon of care. The record could also be used for data mining to evaluate performance. A custom user interface was developed upon the Android™ platform, which has resulted in a “future proof” operating system capable of continually updating and expanding its capabilities:

A. Establishes a seamless methodology for the retention and updating of essential medical/operational information between the classroom and the field.

B. Ensures optimum performance (confidence/ability) of the operator in completion of medical and operational tasks under highly stressful conditions.

C. Provide an audio/video record of the Field Medical Card and a method for a detachable documentation file for the next echelon of care.

D. Android™ OS provides a platform which allows for generational feature expansion and unlimited application topics.

### ODIScentral.com

www.ODIScentral.com is a secured password protected website which allows ODIS users access to a wealth of material for download onto ODIS.

A. APPLICATIONS: Contains new applications and updates to current applications for download onto ODIS.

B. LIBRARY: Contains relevant reference material, textbook, and field manuals for download onto ODIS.

C. VIDEO ROOM: Contains training/instructional videos for download onto ODIS.

D. AUDIO ROOM: Contains instructional audio tracks for download onto ODIS.

E. SYSTEM UPDATE: Provides firmware updates to enable new capabilities on ODIS.

The ODIS Device may also comprise a telemedicine support product that may function much more than as an electronic version of medical handbooks. As evidenced by the literature and military articles, ODIS, in future generations, could morph into a complete reference system with not just complete volumes of vital reference materials, but materials vital to each individual operator's specific skill set and/or operational parameters.

ODIS, may also utilize emerging technologies, and may act as patient monitoring device. Each person in the field may carry or be fitted with an individual casualty device or other monitoring device which is capable of monitoring one or more of such person's location, heart rate, respiration rate, blood pressure, body temperature, physical activity, motion, posture, trending information, ECG, pulse oximetery, perform a 12 lead EKG, and/or monitor other vial signs and/or any other detectable signal or data, and transmit such signal or data to handheld unit 1100 and/or server 1200, and on to the next echelon of care. It is also possible to configure and use handheld unit 1100 as a diagnostic tool like a handheld ultrasound device as well.

Such signal or data may be transmitted from each individual monitoring device via any wired or wireless means including, but not limited to, secure and unsecured cellular networks, global positioning systems, internet channels, telephone networks, and/or other data transmission systems. The signal or data may be transmitted from each individual monitoring device to handheld unit 1100 and/or to a server 1200. In addition, in certain embodiments of the invention, such signal or data may be transmitted over system 1000 from one handheld unit 1100 to another handheld unit 1100, and/or from a handheld unit 1100 to server 1200, and/or from server 1200 to one or more handheld units 1100. Also, other embodiments of the invention may permit the transmission of signals or data from handheld units 1100 directly or indirectly to other servers in communication with, or having access to, the network associated with system 1000.

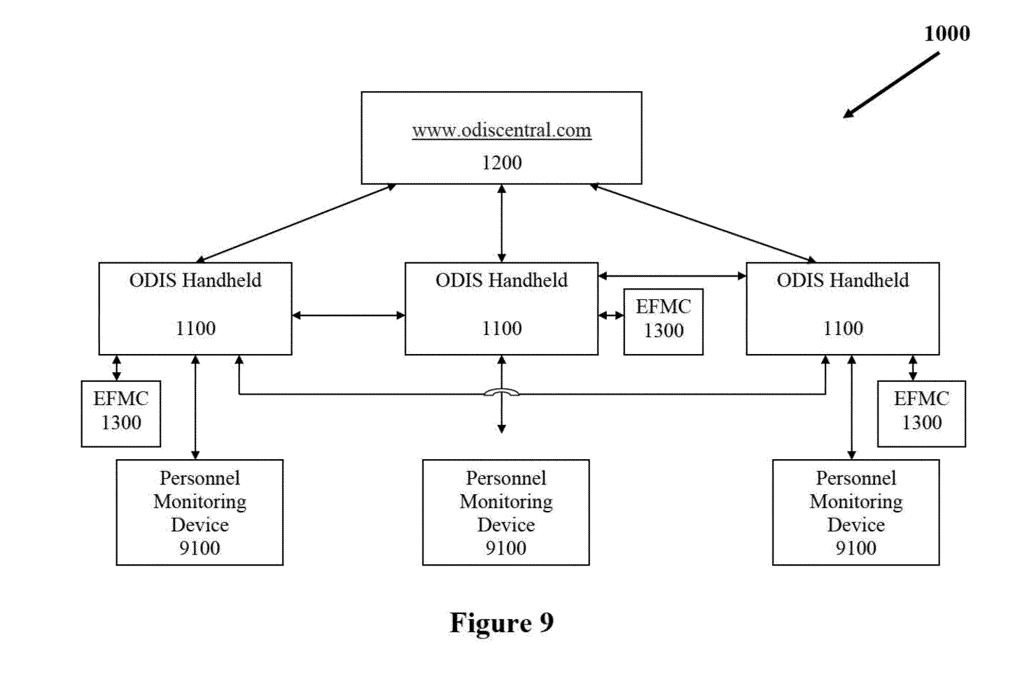

FIG. 9 depicts system 1000 which comprises an embodiment of the invention which permits monitoring of persons and/or patients in the field through personnel monitoring devices 9100. Personnel monitoring devices 9100 allow a user of handheld unit 1100 to monitor certain information or other data associated with one or more field personnel or patients wearing, in possession of, or otherwise in communication with a monitoring device 9100. Such information or other data may include but not be limited to a person's location, heart rate, respiration rate, blood pressure, body temperature, physical activity, motion, posture, trending information, ECG, pulse oximetery, perform a 12 lead EKG, and/or monitor other vial signs and/or any other detectable signal or data, and transmit such signal or data.

For example, and with reference to FIG. 9, the vital signs of a person in the field wearing or otherwise in possession of monitoring device 9100 may be continuously monitored by medical personnel through handheld device 1100. Handheld device 1100 may be configured to continuously and/or concurrently receive data from one or more monitoring devices 9100 so that medical or other personnel using handheld device 1100 may monitor the vial signs of one or more persons in the field in possession of a monitoring device 9100.

In yet another embodiment of the invention, and with reference to FIG. 9, data or other information received by a handheld device 1100 may be transmitted by handheld device 1100 to one or more other handheld devices 1100 and/or to server 1200. In one embodiment of the invention one handheld device 1100 may monitor up to five (5) monitoring devices 9100, however the handheld device of this invention may be configured to monitor one or more monitoring devices 9100. In addition, system 1000 may be configured to allow data or other information received by handheld devices 1100 to be transmitted by handheld devices 1100 to EFMC 1300, and/or monitoring devices 9100. Similarly, system 1000 may be configured to allow data or other information received by EFMC 1300, and/or monitoring devices 9100, to be transmitted to or to be retrieved by handheld devices 1100.

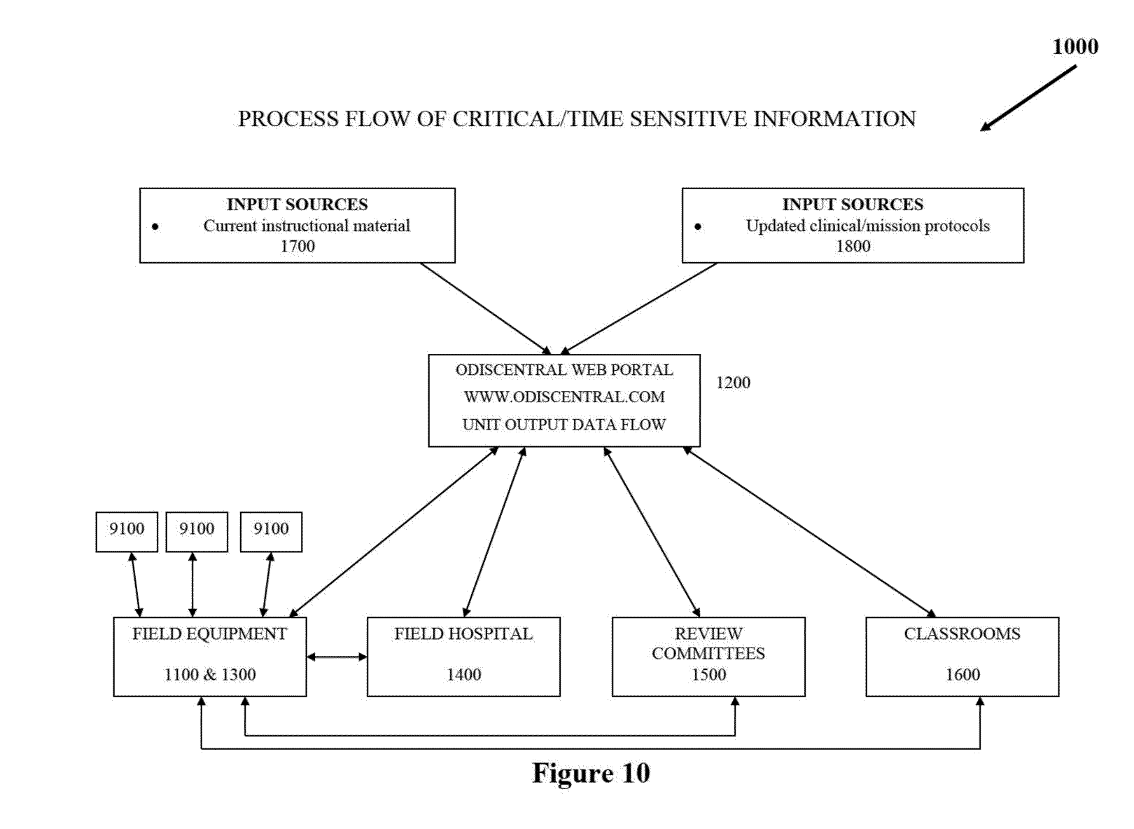

FIG. 10, depicts another embodiment of the flow of information and data through system 1000 of the instant invention. In this embodiment, server 1200 receives, stores, makes available for retrieval and/or transmits information and data from one or more input sources 1700 and 1800. Information and data may also be received from other sources external to server 1200, stored by or in server 1200, retrieved by sources external to server 1200, and/or transmitted by server 1200 to sources external to server 1200.

For example, and with reference to FIG. 10, the vital signs of a person in the field wearing or otherwise in possession of monitoring device 9100 may be continuously monitored by medical personnel through handheld device 1100. Handheld device 1100 may be configured to continuously and/or concurrently receive data from one or more monitoring devices 9100 so that medical or other personnel using handheld device 1100 may monitor the vial signs of one or more persons in the field in possession of a monitoring device 9100.

In addition, the embodiment of system 1000 depicted in FIG. 10 may process data or other information received by handheld device 1100 from one or more personnel monitoring devices 9100 by transmitting such data or other information one or more other handheld devices 1100 and/or to server 1200. In one embodiment of the invention, one handheld device 1100 may monitor up to five (5) monitoring devices 9100, however handheld device 1100 of this invention may be configured to monitor one or more monitoring devices 9100. In addition, system 1000 may be configured to allow data or other information received by handheld devices 1100 to be transmitted by handheld devices 1100 to EFMC 1300, and/or monitoring devices 9100. Similarly, system 1000 may be configured to allow data or other information received by EFMC 1300, and/or monitoring devices 9100, to be transmitted to or to be retrieved by handheld devices 1100.

FIG. 10 also depicts an embodiment of system 1000 wherein information and data may also be received from, retrieved by, and/or transmitted to one or more handheld units 1100 (with or without EFMC 1300). Similarly, information and data may be received from, retrieved by, and/or transmitted from handheld units 1100 to one or more field hospitals and/or other medical facilities 1400, review committees and other individuals or authorities 1500, classrooms an other educational organizations and/or facilities 1600, and/or other sources internal or external to system 1000.

In addition, other embodiments of the invention may permit the transmission of signals or data from handheld units 1100 directly or indirectly to other servers located at field hospitals 1400, classrooms 1600, associated with review committees 1500 and/or to any other desired location in communication with, or having access to, the network associated with system 1000.

System 1000 may be configured to allow any server or device internal or external to system 1000 to transmit and/or to receive data or other information from any other server and/or device internal or external to, but in communication with, system 1000. For example, system 1000 could be configured to allow for the direct transmission of data or other information generated by personnel monitor 9100 directly to field hospital 1400. Similarly, review committee 1500 may transmit to, or otherwise share data directly with, field hospital 1400 and/or one or more personnel monitors 9100. Accordingly, any desired flow of data or other information between servers and/or devices internal or external to system 1000 may be configured and is contemplated by the system and method of the instant invention.

Other utilities and applications of ODIS may include:

A. Advanced Tactical Provider(ATP) protocols.

B. EOD/UXO/Sapper operations materials.

C. Area of operations maps.

D. Dive tables.

E. CBRNE operations/reference materials.

F. Sensitive site exploitation (SSE) video graphic/photographic/verbal intelligence collection.

G. GPS/blue force tracking.

H. Translator (Verbal translator).

I. Secure GSM PTT communications worldwide).

In yet other embodiments system 1000 may include one or more of the following features:

A. A handheld casualty documentation apparatus.

B. A ruggedized exterior casing.

C. Power supply features including internal battery, solar collector, crank wind up.

D. Multiple output interface ports for data transmission and classroom display.

E. An input port allowing for additional audio information to be collected.

F. an integrated camera/video recorder/microphone to generate casualty data records.

G. A method of transmitting vital data with the casualty.

H. A method of retaining casualty records within the care provider's apparatus.

I. A method of keeping the care provider updated with latest protocol changes.

J. A method to view data on the screen in all environmental conditions.

K. A method to utilize directional controls in complete darkness

L. A method to provide clinical and operational updates/communications to apparatus users.

M. A method to provide and keep critical skills current.

The disclosure herein is directed to the variations and modifications of the elements and methods of the invention disclosed that will be apparent to those skilled in the art in light of the disclosure herein. Thus, it is intended that the present invention covers the modifications and variations of this invention, provided those modifications and variations come within the scope of the appended claims and the equivalents thereof.

What is claimed is:

1. A portable device for providing health care personnel located in remote areas with medical treatment information comprising:
a display;
controls for controlling application functions available in connection with said device;
a transceiver for transmitting data from and receiving data by said device; and
an electronic field medical card for storage and transporting of an individual's medical information,
wherein said individual's medical information may be input into said device, uploaded to said electronic field medical card, stored in and retrieved from said electronic field medical card, and may be downloaded to said device for use of said medical information in connection with said applications.

2. The device of claim 1 wherein said medical information may be transmitted from said device.

3. The device of claim 1, wherein said medical information may be received through said transceiver from a source other than said electronic field medical card.

4. The device of claim 1, wherein said medical information may comprise one or more of medical diagnostic and procedural information.

5. The device of claim 1, wherein said medical information may be transmitted through said transceiver to a next echelon of health care for medical treatment of said individual.

6. The device of claim 1, wherein said electronic field medical card contains medical information related only to said individual.

7. The device of claim 1, wherein said medical information related to said individual and applications and updates to said applications may be downloaded to said device through said transceiver.

8. A system for providing health care personnel located in remote areas with medical treatment information, said system comprising:
one or more modular handheld units which are capable of receiving, storing and processing medical information and applications; and
one or more electronic field medical cards, each of which comprises a portable data storage device capable of storing medical information related to an individual, and wherein said medical information contained on said electronic field medical cards may be uploaded to said handheld unit, and downloaded from said handheld unit to said electronic field medical card.

9. The system of claim 8, wherein said medical information may comprise one or more of medical procedures, skills, techniques, protocols, and medical information related to an individual.

10. The system of claim 8, wherein said applications may comprise one or more software applications related to medical procedures, skills, techniques, protocols, and medical information related to an individual.

11. The system of claim 9, wherein said applications may be in one or more of audio and video form.

12. The system of claim 8, further comprising a server in communication with said one or more handheld units.

13. The system of claim 12, wherein one or more of said medical information and applications may be downloaded from said server to said one or more handheld units.

14. The system of claim 12, wherein said medical information may be uploaded from said one or more handheld units to said server.

15. The system of claim 8, wherein said medical information may be transmitted from at least one of said handheld units to another said handheld unit.

16. The system of claim 12, wherein said medical information may be transmitted from at least one of said handheld units to one or more of another said handheld unit and said server.

17. The system of claim 12, wherein said server comprises a website.

18. The system of claim 8, further comprising a personnel monitoring device worn by or in the possession of said individual, wherein said personnel monitoring device associated with said individual is in communication with said one or more of said handheld devices therein enabling said health care personnel to monitor certain information or other data associated with individual.

19. A system for providing health care personnel located in remote areas with medical treatment information, said system comprising:
one or more modular handheld units which are capable of receiving, storing and processing medical information and applications;
a server in communication with said one or more handheld units; and
one or more electronic field medical cards, each of which comprises a portable data storage device capable of storing medical information related to an individual, and wherein said medical information contained on said electronic field medical cards may be uploaded to said handheld unit, and downloaded from said handheld unit to said electronic field medical card.

20. The system of claim 18, further comprising a personnel monitoring device worn by or in the possession of said individual, wherein said personnel monitoring device associated with said individual is in communication with said one or more of said handheld devices therein enabling said health care personnel to monitor certain information or other data associated with individual.
